(19) United States
(12) Patent Application Publication
(10) Pub. No.: US 2018/0125061 A1
(43) Pub. Date: May 10, 2018

(54) BIRD SHOOTING STICK

(71) Applicants: James Komater, Ottawa, IL (US); Ryan Gunderson, Ottawa, IL (US)

(72) Inventors: James Komater, Ottawa, IL (US); Ryan Gunderson, Ottawa, IL (US)

(21) Appl. No.: 15/345,562

(22) Filed: Nov. 8, 2016

(51) Int. Cl. A01M 31/02; F16M 11/28; F41A 23/06

(52) U.S. Cl. CPC A01M 31/02; F41A 23/06; F16M 11/28

(57) ABSTRACT

This invention relates to a portable supporting structure for a firearm having a detachable cradle to hold the firearm mounted on an elongated tubular member, a spindle mechanism operably adapted to fix the detachable cradle with the elongated tubular member at a proximal end, a lever operably adapted to adjust the height of the elongated tubular member and a base platform to hold the elongated tubular member. Further, the portable supporting structure is simple and inexpensive to manufacture.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### (1) Field of the Invention

The present invention relates to the field of portable supporting structure for firearm, crossbow and the like. The invention, particularly relates to a portable supporting structure having a detachable means from their assemblies.

### (2) Background of the Invention

In recent years, many weapon supporting devices have been utilized in the past. But none has addressed the problems encountered by young, elderly and infirm shooters that can be operated with a single hand. Most of the prior devices are little more than the shooting stand in which the weapon is placed. Security of the weapon is enhanced a little if at all.

Conventionally, a variety of weapon configurations, and adjusts to the preference of the shooter as to the positioning of the weapon, horizontally, and with respect to elevation and azimuth of the sights. This is affected by the physical size of the shooter and is a matter of bracing, and of comfort.

There have been a number of solutions provided for effective supporting shooting stand and few of them have been discussed below:

U.S. Pat. No. 7,484,699 B1 discloses a tubular staff has sections which can be collapsed one into the other down to a very small size. The sections are held together by peripheral clamps snap-tightened by a small lever. There is a ground spike at the bottom of the staff which itself can be removed and stowed within the staff. A firearm cradle can be on top and one end of a small elbowed rod goes either into the top of the staff or into the cradle, if one's there. The rod's other end attaches to a hole in a hunting bow to support it until game arrives. Instead of the elbowed rod, an accessory supporting structure can likewise be set into the staff or cradle. The linkage of the accessory support is a bendable length of ball and socket joints available from certain industrial sources so that the camera angle or telescope can be properly manipulated.

U.S. Pat. No. 5,903,995 A describes a device for supporting a hunting rifle, pistol or other firearm that permits the rifle to rotate to allow a full range of targeting while providing stable support in a confined area. The supporting device includes a base to support the device on a surface, a vertical supporting leg and a rest to support a rifle. One end of the supporting device is secured to the base via a swivel and the other end of the supporting device is secured to the rest via a swivel. The swivels provide rotational movement of the supporting leg relative to the base, and rotational movement of the rest, and consequently of the rifle, relative to the supporting leg. The swivels can be set at varying tensions or stiffness. The rifle can be attached to the rest. To aid in the transportation of the rifle and support device, the supporting leg can be folded and clamped onto a clamp of the rest, so that the supporting leg and base are parallel to the rifle.

U.S. Pat. No. 5,345,706 A relates to a firearm support with a receiving and attachment means for receiving the firearm and securely holding it. The attachment means engages with the sling mount bolt of a firearm and draws the firearm and firearm support tightly but releasably together. The attachment means includes gripping arms with pins that engage a sling bore in the sling mount bolt. The attachment means also includes a fixed body or neck with an inner bore that receives the sling mount bolt and gripping arms. The inner bore has an elongate camming surface to engage an outer surface on the gripping arms for urging the pins into the sling bore and holding them in place as the gripping arms and sling mount bolt are pulled into the inner bore. The firearm support includes a telescoping leg that has an internal lock to maintain the leg in a closed or carrying position with respect to the firearm. Adjustment means are provided to position the telescoping leg substantially parallel to the barrel of the firearm when in the folded carrying position.

U.S. Pat. No. 7,500,328 B1 pertains a shotgun shooting stick comprising an adjustable length hollow pole having a pair of retractable legs stored therein when not in use and first and second connectors to couple the hollow pole in a parallel configuration underneath a barrel of a shotgun.

A major drawback of the current art is the lack of rigidity in the support mechanisms. As shooting requires a very exact sighting base, many of the current art devices are not satisfactory in that regard. It is seen, then, that each shooter is individually in need of the ability to adjust each of these parameters to his own physical preference. Many of the current art devices are suitable only for very gross adjustments to be made, resulting in increments which may not be satisfactory for a particular shooter.

Accordingly, there remains a need in the prior art to have an improved shooting stand for firearms, crossbow and the like, to provide a rigid base having detachable components, through a wide range of size as per the requirement of the user, which can also perform the easy installation of the device and provides the users a wide space to hold the firearms, therefore overcome the aforesaid problem and shortcomings.

### SUMMARY OF THE INVENTION

In the view of the foregoing disadvantages inherent in the known types of shooting supporting stand now present in the prior art, the present invention provides an improved portable supporting stand for a firearm or a crossbow. As such, the general purpose of the present invention, which will be described subsequently in greater detail, is to provide a new and improved portable supporting structure for a firearm having a variable size of a detachable cradle for multiple size of firearms, which has all the advantages of the prior art and none of the disadvantages.

An object of the invention is to provide a portable supporting stand having a detachable cradle to hold the firearm, which is mounted on an elongated tubular member.

It is another object of the present invention to provide the portable supporting stand having a spindle mechanism, i.e. operably adapted to fix the detachable cradle at a proximal end.

It is another object of the present invention to provide the portable supporting stand having a lever, i.e. operably adapted to extend said elongated tubular member.

It is another object of the present invention to provide the portable supporting stand, preferably, which is mounted on, but not limited to, a detachable rectangular base platform to hold said elongated tubular member.

It is another object of the present invention to provide the portable supporting stand that can be fitted in a deer stand and further, the height of the stand can be adjusted using one hand of the user while holding the firearm or crossbow in the other hand of the user.

It is another object of the present invention to provide the portable supporting stand having a detachable and folded element for easy carrying with easy handling.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a portable supporting structure with a detachable base and cradle in accordance with an embodiment of the present invention.

FIG. 2 illustrates the detachable cradle of the portable supporting structure as shown in FIG. 1.

FIG. 3 illustrates the portable supporting structure having the cradle with an elongated tubular member as shown in FIG. 1.

### DETAILED DESCRIPTION OF THE INVENTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides a portable supporting structure comprises a detachable cradle (1), an elongated tubular member (3), a lever (2), a detachable base platform (5) and a spindle mechanism. Further, the detachable cradle is of the variable size as per the need of the user.

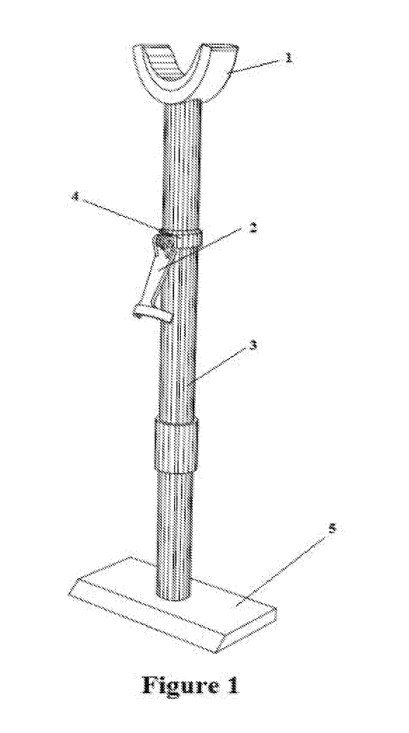

FIG. 1 shows a perspective view of the portable supporting structure of the present invention. The portable supporting structure or stand is having a detachable base platform (5) to provide a suitable space for elongated tubular member (3) such that the user can easily hold the firearm or crossbow without any lashing up.

In accordance with an embodiment of the present invention, the portable supporting structure is configured to stabilize the stand by a detachable base onto the ground with a pivotally placed an elongated tubular member mounted on the base, for a cradle (1), preferably, the size of the cradle is, but not limited to, (1¾×2½)″ inch. Further, the longitudinally elongated tube is connected to a lever for adjusting the level or the height of the longitudinally elongated tubular member. The elongated tubular member is divided into the sections or channels for easy elongation or folding to disassemble the stand. The channels of the elongated tubular member are covered with a fabric or the like material. Preferably, the fabric is made of material selected from a group of fade resistant, water resistant long lasting fabric.

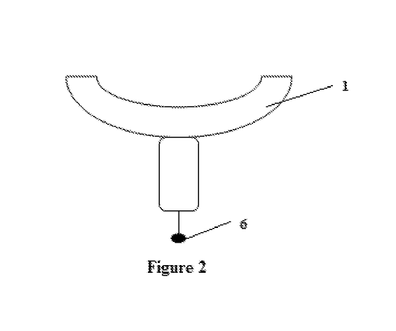

FIG. 2 is the detachable cradle of the portable supporting structure of FIG. 1. The present invention provides a very simple stand with a variable size of cradle for receiving a firearm or crossbow. Also, the cradle (1) is having a spindle mechanism operably adapted to fix the detachable cradle at a proximal end with the elongated tubular member.

In accordance with an embodiment of the present invention, the spindle mechanism is supported by a spheroid structure (6), which is placed at the proximal end of the detachable cradle. Preferably, the detachable cradle is made of material selected from a group of, but not limited to, hard rubber, synthetic rubber, synthetic plastic or a combination thereof, although any other suitable material can also be used as per the requirement by the producer.

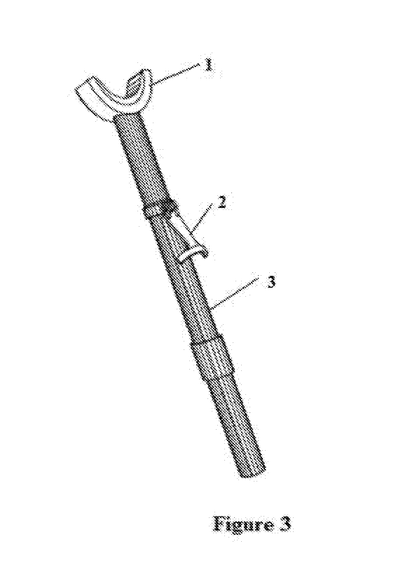

FIG. 3 shows the portable supporting structure having the cradle with an elongated tubular member of the FIG. 1. The portable supporting structure is configured to hold, but not limited to, a firearm or a crossbow as per the user desired level or height using the lever (2). The lever is operably adapted to extend the elongated tubular member, which is disposed circumferentially around said elongated tubular member using a mechanical means. The mechanical means is a collar (6), which is circumferentially movable to the elongated tubular member with the lever.

The above-mentioned portable supporting structure provides durable construction. Further, the user has a set of potable attachments for building the shooting stand, therefore easy to carry by the handle of the stand and moving from one to another place. In addition, the stand is simple and easy to use at any place. The anchor of the stand helps to protect it from any tangling and provides stability. Further, it eliminates the need to carry out the heavy weight elements for shooting, hunting or the like while the person is travelling.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A portable supporting structure for a firearm, comprising:
An elongated tubular member;
a detachable cradle to hold said firearm mounted on said elongated tubular member;
a spindle mechanism operably adapted to fix said detachable cradle with said elongated tubular member at a proximal end;
a lever operably adapted to adjust the height of said elongated tubular member; and
a detachable base platform to hold said elongated tubular member.

2. The portable supporting structure according to claim 1, wherein said spindle mechanism is supported by a spheroid structure.

3. The portable supporting structure according to claim 2, wherein said spheroid structure is placed at said proximal end of said detachable cradle.

4. The portable supporting structure according to claim 1, wherein said detachable cradle is made of material selected from a group of hard rubber, synthetic rubber, synthetic plastic or a combination thereof.

5. The portable supporting structure according to claim 1, wherein said lever is disposed circumferentially around said elongated tubular member using a mechanical means.

6. The portable supporting structure according to claim 5, wherein said mechanical means is a collar.

7. The portable supporting structure according to claim 6, wherein said collar is circumferentially movable to said elongated tubular member with said lever.
